(19) United States
(12) Patent Application Publication
(10) Pub. No.: US 2004/0066611 A1
(43) Pub. Date: Apr. 8, 2004

(54) Computer keyboard with backup battery

(76) Inventor: Michael Wu, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/263,713

(22) Filed: Oct. 4, 2002

(51) Int. Cl. G06F 1/16

(52) U.S. Cl. 361/680; 400/472

(57) ABSTRACT

A computer keyboard includes a first recess for removably receiving a battery module and a second recess for rotatably receives a connector module. A connection port is formed on the connection module for connection with an external electronic device. Preferably, the second recess comprises a foldable support mechanism for supporting the external electronic device. The computer keyboard is formed with a computer connection port for connection with a host computer via a cable. A printed circuit board is provided in the keyboard and electrically connected with a socket of the first recess and a contact of the second recess. A socket is formed on the computer keyboard, which is electrically connected with an external power source via a cable for charging the battery module mounted in the first recess or charging the electronic device connected to the second recess.

### BACKGROUND OF THE INVENTION

1. Field of the Invention

The present invention relates generally to a computer keyboard, and in particular to a computer keyboard with a backup power energy supplying device.

2. The Related Art

Keyboards are one of the most commonly used input devices for computers. A keyboard comprises a flat, rectangular base having a top face on which a number of operation keys are movably mounted. Usually, the keyboard is electrically connected to an electronic device, such as a host computer, via a cable. The electrical power energy required by the keyboard for operation is supplied from the host computer through the cable. Recently, portable electronic devices, such as notebook computer and Personal Digital Assistant (PDA), are used widely. These portable electronic devices are mostly powered by battery pack. Once the electrical power energy of the battery pack is exhausted, the electronic devices can not be operable.

Normally, the keyboard base is made of rigid plastic material that makes it impossible to be folded. With the trend of miniaturization of computers and peripheral devices, the overall size of keyboards is substantially reduced, such as the key pad of a notebook computer. Some of the electronic devices employ a “touch panel” to replace the keyboard. An example of the electronic devices that employs the touch panel is a Personal Digital Assistant (PDA). Since the PDA has a display screen having a very limited surface area for display. The touch panel is integrated with the display and thus is limited in size. This makes it difficult for a user to “touch” the desired zones on the display surface of the PDA. Thus, an external keyboard may be required for helping data input into the PDA. However, as described above, once the electrical power energy of the battery pack of the PDA is exhausted, the PDA can not be operable.

Thus, it is desired to have a computer keyboard equipped with power energy supplying device for supplying power energy to the connected electronic device.

### SUMMARY OF THE INVENTION

Thus, a primary object of the present invention is to provide a computer keyboard with backup battery that can supply power energy to an external device connected to the keyboard.

Another object of the present invention is to provide a computer keyboard for a Personal Digital Assistant (PDA). The keyboard is provided with backup battery set that can supply power energy to the Personal Digital Assistant.

A further object of the present invention is to provide a computer keyboard and selectively connects the PDA to a host computer.

To achieve the above objects, in accordance with the present invention, there is provided a computer keyboard with backup battery which comprises a first recess for removably receiving a battery module and a second recess for rotatably receiving a connector module. A connection port is formed on the connection module for connection with an external electronic device e.g. Personal Digital Assistant (PDA). Preferably, the second recess comprises a foldable support mechanism for supporting the PDA. When the PDA is out of power, the battery module can provide power to the PDA connected to the keyboard. The computer keyboard is provided with a computer connection port for connection with a host computer via a cable. A socket is formed on the computer keyboard, which is electrically connected with an external power source via a cable. Thereby, power is supplied for charging the battery module in the first recess, or alternatively for charging the PDA connected to the second recess.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a computer keyboard with a backup battery pack in accordance with the present invention in connection with an electronic device;

FIG. 2 is an exploded view showing the battery pack and connection module separated from the computer keyboard of the present invention;

FIG. 3 is an enlarged view of the encircled portion A of FIG. 2; and

FIG. 4 is a perspective view showing the support plate of the support mechanism is rotated at a supporting position.

### DETAILED DESCRIPTION OF THE PREFERRED EMBODIMENTS

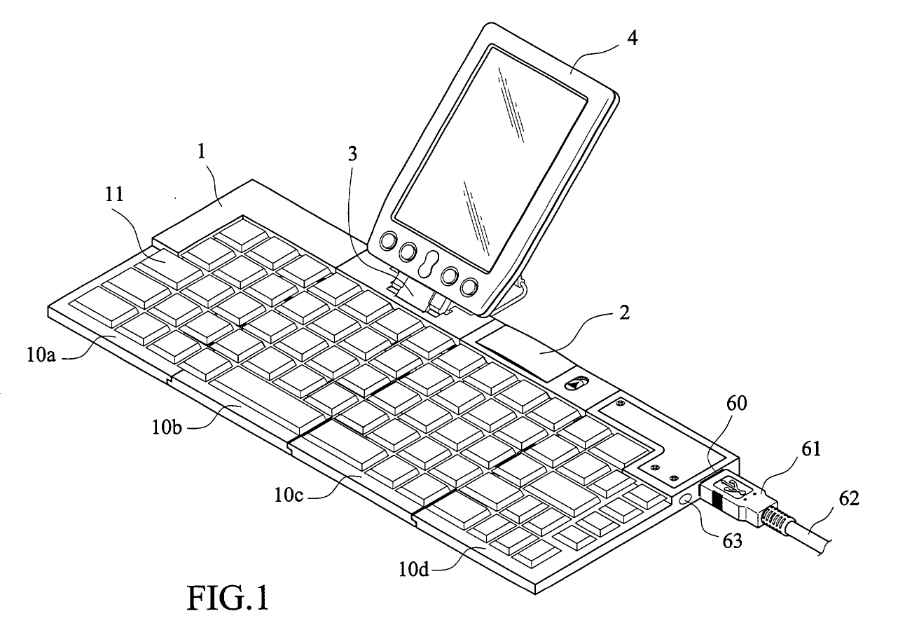

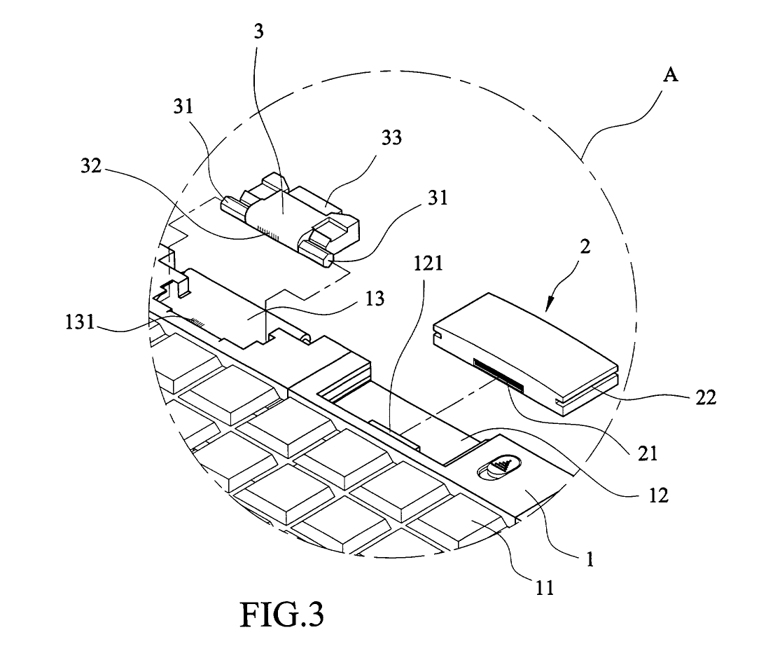

With reference to the drawings and in particular to FIGS. 1 to 3, a computer keyboard with backup battery constructed in accordance with the present invention is shown. The computer keyboard 1 comprises a number of operation keys 11 arranged on a top face (not labeled) of the keyboard 1. Adjacent to the rear edge of the keyboard 1, there is a first recess 12 for removably receiving a battery module 2. The battery module 2 comprises connection means having a plug 21 formed on the battery module 2 and engageable with a socket 121 formed in the recess 12 to electrically connect the battery module 2 to the keyboard 1.

A guide slot 22 is defined in and co-extensive with each side edge of the battery module 2 for receiving and being guided by ribs (not labeled) on opposite side walls of the first recess 12. Latch means (not shown) may be provided to releasably retain the battery module 2 in the first recess 12. Alternatively, a manual release button may be formed on the keyboard 1 for releasing the battery module 2.

A second recess 13 is provided adjacent to the first recess 12 of the keyboard 1. The second recess 13 rotatably receives a connector module 3 which comprises a contact 32 at the rear side for engaging with a mating contact 131 formed in the second recess 13. A connection port 33 is formed on the connection module 3 for connection with an external electronic device e.g. Personal Digital Assistant (PDA), which is generally designated with reference numeral 4 in FIG. 1. The connector module 3 preferably comprises pivot shafts 31 having polygonal cross section for selectively retaining the connector module 3 at different angular position.

Although the PDA 4 itself is equipped with a power source, it may happen that the PDA 4 is running out of the power energy. The battery module 2 of the keyboard provides an alternative choice for power supply to the PDA 4. Thus, even the PDA 4 is running out of its own power, the PDA 4 still can be operative.

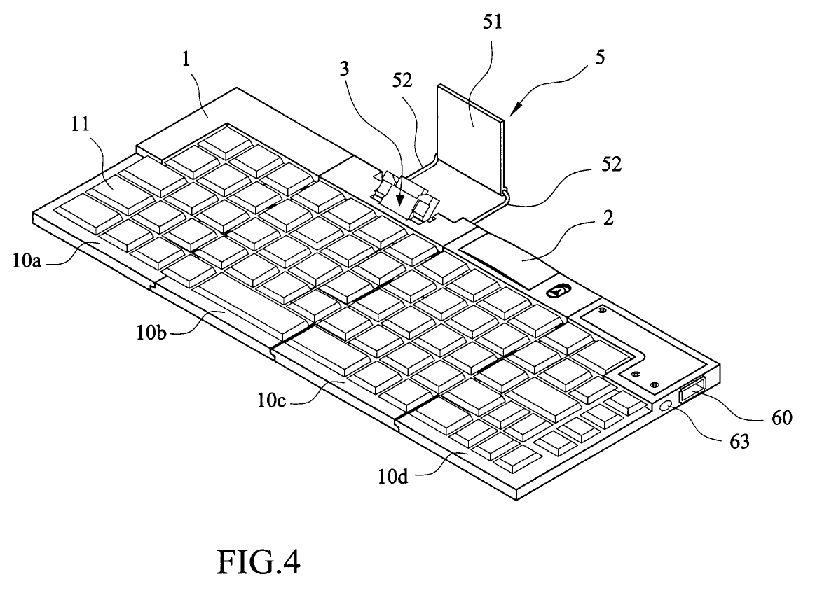

Also referring to FIG. 4, preferably, the second recess 13 comprises a foldable support mechanism 5 having two parallel and spaced legs 52. A support plate 51 is rotatably mounted between the legs 52 and is rotated to an upright position for supporting the PDA 4. The support plate 51 is also movable to a stowed position substantially parallel to and between the legs 52, so that the support keyboard mechanism 5 can be completely pushed into and received in an inside space (not shown) of the recess 13. The PDA 4 that is supported by the support keyboard plate 51 is connectable with the connector module 3 for electrical connection with the keyboard 1.

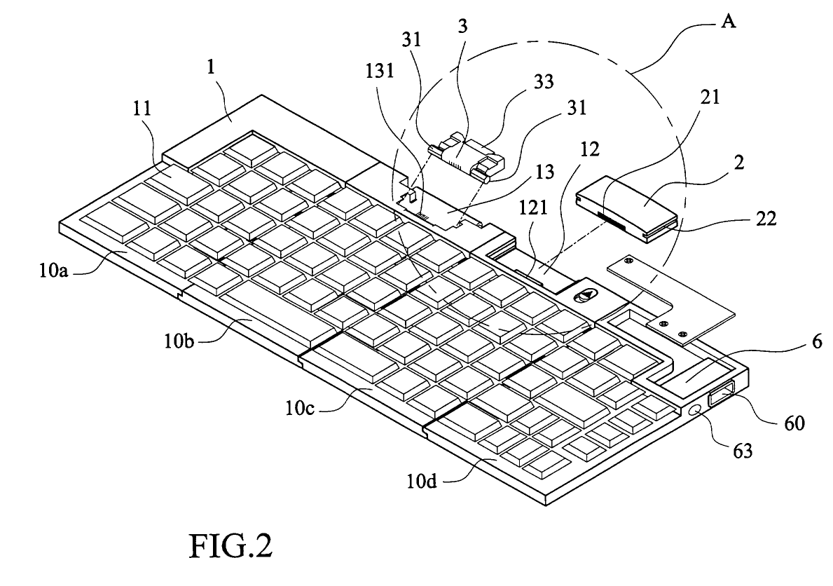

The keyboard 1 is provided with a printed circuit board 6 as shown in FIG. 2. The printed circuit board 6 is electrically connected to the socket 121 of the first recess 12 and the mating contact 131 of the second recess 13. The printed circuit board 6 is provided with a computer connection port 60, such as a Universal Serial Bus (USB) connector, for connection with a host computer (not shown) via a USB cable 62. This allows the PDA 4 to be connected to the host computer for data transmission.

The printed circuit board 6 is also provided with a socket 63 which is electrically connected with an external power source (not shown) via a cable (not shown). With the socket 63, the external power source is supplied for charging the battery module 2 mounted in the first recess 12 of the keyboard 1, or alternatively for charging the PDA 4 connected to the second recess 13.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A computer keyboard with a backup battery comprising:
a frame;
a first recess formed on the frame, which comprises a socket; and
a battery module formed on the frame, which is removably received in the first recess and comprises a plug for connection with the socket of the first recess when the battery module is received in the first recess.

2. The computer keyboard as claimed in claim 1, wherein the keyboard further comprises a second recess which rotatably receives a connector module for releasable connection with an external electronic device.

3. The computer keyboard as claimed in claim 2, wherein the connector module comprises pivot shafts for selectively retaining the connector module to the second recess and a contact for connection with a mating contact formed in the second recess.

4. The computer keyboard as claimed in claim 2, wherein the second recess further comprises a foldable support mechanism having two parallel and spaced legs with a support plate rotatably mounted between the legs and rotatable to an upright position for supporting the external electronic device.

5. The computer keyboard as claimed in claim 2, wherein the external device is a personal digital assistant.

6. The computer keyboard as claimed in claim 1, wherein the battery module further comprises a pair of guide slot on each side edge.

7. The computer keyboard as claimed in claim 1, wherein the keyboard is formed with a computer connection port for connection with a computer via a cable.

8. The computer keyboard as claimed in claim 7, wherein the computer connection port comprises a Universal Serial Bus connector.

9. The computer keyboard as claimed in claim 1, wherein the computer keyboard is formed with a socket which is connected to an external power source via a cable for supplying power to the battery module.
